(19) United States
(12) Patent Application Publication
(10) Pub. No.: US 2009/0074230 A1
(43) Pub. Date: Mar. 19, 2009

(54) Electronic watermark embedding device and detection device, detection method, detection program, and intergrated circuit device thereof

(76) Inventors: Ken'ichi Noridomi, Fukuoka (JP); Hisashi Inoue, Fukuoka (JP); Masataka Ejima, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/918,883

(22) PCT Filed: Apr. 18, 2006
(86) PCT No.: PCT/JP2006/308146

§ 371 Date: Oct. 19, 2007

(30) Foreign Application Priority Data
Apr. 21, 2005 (JP) 2005-123217

(51) Int. Cl. G06K 9/00

(52) U.S. Cl. 382/100

(57) ABSTRACT

An electronic watermark technique which allows precise detection of electronic watermark information from image having any size is provided. In an electronic watermark embedding device 100, an image size obtaining section 101 obtains an image size. A block size determination section 102 defines an area formed of a plurality of pixels as a block, and calculates a size of the block based on the image size. An embedding section 103 embeds the electronic watermark in units of the block of the calculated size. In an electronic watermark detection device 700, an image size obtaining section 701 obtains an image size of image data in which the electronic watermark is embedded. A detection filter producing section 702 calculates a size of a detection filter based on the image size. A detection section 703 detects the electronic watermark using correlation between the detection filter having the calculated size and the image data.

### TECHNICAL FIELD

The present invention relates to an electronic watermark technique of embedding additional information to image data based on an image size and detecting the additional information from image data of which resolution has been converted.

### BACKGROUND ART

In recent years, as use of cellular phones with cameras has spread, people more often take pictures casually. There is an attempt to enable obtaining information with cellular phones with cameras by using electronic watermark technique. For example, relevant URL information is embedded to a picture on a magazine or a poster as an electronic watermark, and when a photo of such a picture is taken by cellular phones with cameras, the electronic watermark is detected and the URL information can be obtained.

For detecting the electronic watermark from such a printed image, the image size of the photo taken by the cellular phones with cameras varies depending upon the resolution of the cameras, or the way users take photos. The size of the image data when it is printed on a magazine or a poster cannot be uniquely defined before printing. The electronic watermark is usually embedded to the image data before printing. As described above, since the resolution of the image data is converted due to the resolution of the camera, the way a user takes a photo, or influence caused by printing to a magazine or a poster, a high tolerance is required for electronic watermarks.

Such resolution conversion occurs under various situations, and not limited to when the cellular phones with cameras are used as mentioned above. For example, for reproducing the domestically captured video using a video shooting function abroad, conversion between NTSC and PAL is necessary due to a difference in a signaling system. Further, when video is retrieved by a personal computer and edited, the resolution can be converted freely.

Patent Document 1 discloses a conventional technique which is taking into consideration that the image size at embedding and the image size at detection are different. Patent Document 1 discloses a method of embedding an electronic watermark by having the image size after resolution conversion as a criterion.

Hereinafter, a conventional technique will be described with reference to FIG. 27. FIG. 27 is a block diagram illustrating the conventional technique. First, an image size obtaining section 2701 obtains an image size (hereinafter, referred to as an original image size). Then, a post-conversion image size inputting section 2702 receives an input of an image size after the resolution is converted (hereinafter referred to as a post-conversion image size). The image size input in this step is an image size at detection. Next, a block size calculation section 2703 calculates a block size of the original image based on a magnification percentage between the original image size and the post-conversion image size such that the block size of the image after conversion becomes m×n pixels (m and n are natural numbers). Lastly, an embedding section 2704 embeds an electronic watermark in block units of the original image.

Now, a process of the block size calculation section 2703 is further described in details with reference to FIG. 28. In FIG. 28, a dimension in a horizontal direction of the original image is denoted by H, and a dimension in a vertical direction is denoted by V. The post-conversion image is an image having the resolution converted at a known conversion rate, and has a horizontal dimension denoted by h, and a vertical dimension denoted by v. In FIG. 28, a hatched rectangular area represents a block, which is a unit for embedding electronic watermarks. The block size of the original image (M×N pixels, M and N are natural numbers) is calculated and determined such that the block size after the conversion becomes m×n pixels. In other words, M and N are determined such that V: v=M:m, and H:h=N:n are satisfied. Then, an electronic watermark is embedded to the original image by the block unit of M×N pixels.

According to the above method, an electronic watermark is embedded with the image size after the resolution conversion being the criterion. This allows the electronic watermark to be detected not only from the image having the same size as the original image, but also from the image having a converted image size.

Patent Document 1: Japanese Laid-Open Publication No. 2000-152199

### DISCLOSURE OF THE INVENTION

### Problems to be Solved by the Invention

According to the above conventional technique, electronic watermarks can be detected from images after conversion when the conversion rate is known. However, it has a problem that electronic watermarks cannot be precisely detected when photos of printed images are taken by cellular phones with cameras or the like as described above because the conversion rate cannot be uniquely determined due to resolutions of cameras, the way users take photos, or influences caused by printing to a magazine or a poster.

Further, the above-described conventional technique also has a problem that it is difficult to be applied not only in the case where the image is taken in the above way, but also in any case where the conversion rate is arbitrarily determined.

The present invention is to solve the above-described problems, and object thereof is to provide an electronic watermark technique which allows electronic watermarks to be precisely detected from images having any size.

### Means for Solving the Problems

An electronic watermark embedding device of the first invention is a device for embedding an electronic watermark to image data, including: an image size obtaining section configured to obtain an image size; a block size determination section configured to define an area formed of a plurality of pixels as a block, and calculates a size of the block based on the image size; and an embedding section configured to embed the electronic watermark in units of the block of the calculated size.

An electronic watermark detection device of the third invention is a device for detecting an electronic watermark from image data in which the electronic watermark is embedded, including: an image size obtaining section configured to obtain an image size; a detection filter producing section configured to calculate a size of a detection filter based on the image size; and a detection section configured to detect the electronic watermark using correlation between the detection filter having the calculated size and the image data.

According to these structures, the size of the block is calculated based on the image size when the electronic watermark is embedded, and the detection filter is produced based on the image size at detection to detect the electronic watermark. Thus, electronic watermarks can be detected from an image of any size.

An electronic watermark detection device of the fifth invention further includes an image size expanding section configured to produce image data expanded at a magnification of Z times (Z>1) of the image size, and the image size obtaining section obtains the image size based on the expanded image data.

According to this structure, the image size at detection is expanded and the detection filter is also expanded. Thus, the influence caused by a positional shift in correlation between the detection filter and the image data can be reduced. As a result, the detection tolerance to the positional shift can be improved.

An electronic watermark detection device of the seventh invention further includes an extraction section configured to extract the image data from a second image data which includes the image data.

According to this structure, electronic watermark information can be appropriately detected from a large image data including the embedded image data.

### Effects of the Invention

As described above, according to the present invention, even when an electronic watermark is embedded in block units calculated based on an image size when the electronic watermark is embedded, a detection filter is produced based on an image size at detection and the electronic watermark is detected. Thus, the electronic watermark can be detected from image of any size. In particular, for detecting an electronic watermark from the image of a photo which is taken by, for example, a cellular phone with a camera, the effect of present invention is significant because the image size cannot be determined uniquely in such a case.

Further, by expanding the image size at detection, a detection resistance to a positional shift can be improved.

Moreover, even from larger image data including the image data in which the electronic watermark is embedded, electronic watermark information can be detected appropriately.

### BRIEF DESCRIPTION OF THE DRAWINGS

FIG. 1 is a block diagram of an electronic watermark embedding device according to Embodiment 1 of the present invention.

FIG. 2 is a flow diagram for the electronic watermark embedding device according to Embodiment 1 of the present invention.

FIG. 3 is a diagram for illustrating an electronic watermark embedding process according to Embodiment 1 of the present invention.

FIGS. 4 are diagrams for illustrating embedding patterns according to Embodiment 1 of the present invention.

FIG. 5 is a diagram for illustrating an embedding process according to Embodiment 1 of the present invention.

FIGS. 6 are diagrams showing variations of the image data according to Embodiment 1 of the present invention.

FIG. 7 is a block diagram of an electronic watermark detection device according to Embodiment 2 of the present invention.

FIG. 8 is a flow diagram for the electronic watermark detection device according to Embodiment 2 of the present invention.

FIG. 9 is a diagram for illustrating a detection filter according to Embodiment 2 of the present invention.

FIG. 10 is a diagram illustrating an electronic watermark detection process according to Embodiment 2 of the present invention.

FIG. 11 is a block diagram of an electronic watermark detection device according to Embodiment 3 of the present invention.

FIG. 12 is a flow diagram for the electronic watermark detection device according to Embodiment 3 of the present invention.

FIG. 13 is a diagram for illustrating a detection filter according to Embodiment 3 of the present invention.

FIGS. 14 are diagrams showing examples of the image data according to Embodiment 3 of the present invention.

FIG. 15 is a supplementary diagram for illustrating effects according to Embodiment 3 of the present invention.

FIG. 16 is a supplementary diagram for illustrating effects according to Embodiment 3 of the present invention.

FIG. 17 is a supplementary diagram for illustrating effects according to Embodiment 3 of the present invention.

FIGS. 18 are diagrams showing examples of the image data according to Embodiment 4 of the present invention.

FIG. 19 is a block diagram of an electronic watermark detection device according to Embodiment 4 of the present invention.

FIG. 20 is a flow diagram for the electronic watermark detection device according to Embodiment 4 of the present invention.

FIG. 21 is a block diagram of an electronic watermark detection device according to a variation of Embodiment 4 of the present invention.

FIG. 22 is a flow diagram for the electronic watermark detection device according to the variation of Embodiment 4 of the present invention.

FIGS. 23 are diagrams showing examples of the image data according to the variation of Embodiment 4 of the present invention.

FIG. 24 is a block diagram of an information processing device according to Embodiment 5 of the present invention.

FIG. 25 is a flow diagram for the information processing device according to Embodiment 5 of the present invention.

FIG. 26 is a flow diagram for the information processing device according to Embodiment 6 of the present invention.

FIG. 27 is a block diagram showing a conventional technique.

FIG. 28 is a diagram illustrating the conventional technique.

### REFERENCE NUMERALS

100 electronic watermark embedding device

101 image size obtaining section

102 block size determination section

103 embedding section

700 electronic watermark detection device

701 image size obtaining section

702 detection filter producing section

703 detection section

1101 image size expansion section

1901 area extraction section

2101 imaging section

2102 imaging range control section

2401 input device

2402 CPU

2403 drive

2404 recording medium

2405 storage device

2406 output device

2407 bus

### BEST MODE FOR CARRYING OUT THE INVENTION

Hereinafter, embodiments of the present invention will be described with reference to drawings.

### Embodiment 1

First, a device for embedding an electronic watermark to image data according to Embodiment 1 of the present invention will be described.

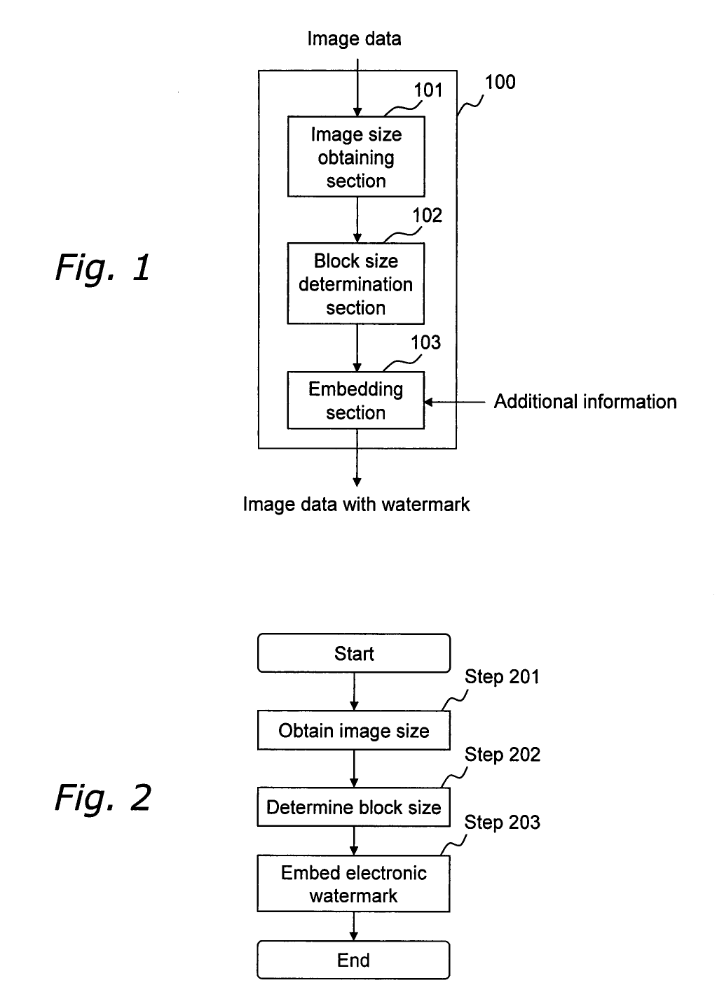

FIG. 1 is a block diagram of an electronic watermark embedding device 100 with respect to image data according to Embodiment 1. As shown in FIG. 1, the electronic watermark embedding device 100 of the present embodiment includes an image size obtaining section 101, a block size determination section 102 and an embedding section 103.

Now, the electronic watermark embedding device 100 of the present embodiment is described with further reference to FIG. 2. FIG. 2 is a flow diagram for the electronic watermark embedding device 100 shown in FIG. 1.

First, the image size obtaining section 101 obtains a horizontal direction dimension H and a vertical direction dimension V from input image data (step 201). In this example, the input image data is a rectangular image of H=360 (pixels) and V=240 (pixels).

Next, the block size determination section 102 calculates a size of a block based on the image size (step 202). Assuming that a horizontal direction dimension of the block is n pixels and a vertical direction dimension is m pixels, the rule to be applied is that H:n=60:1, and V:m=40:1 are satisfied. According to this rule, the block size is calculated to be 6×6 pixels.

At last, the embedding section 103 embeds input additional information in the block unit determined at step 202 as an electronic watermark, and outputs image data with the watermark (step 203).

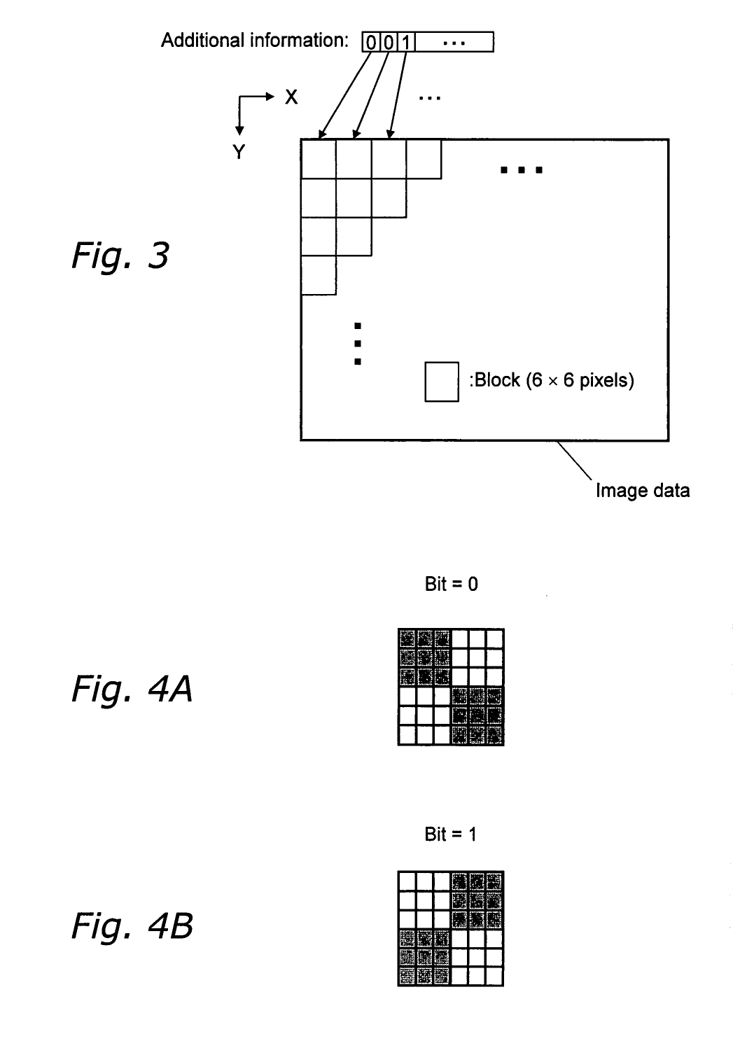

Now, the process at step 203 will be further described in details with reference to FIGS. 3 through 5. FIG. 3 shows a relationship between a bit sequence of the additional information and the blocks. As shown in FIG. 3, the image data is divided into block units, and starting from the block on the upper left corner, the bits in the bit sequence of the additional information are embedded to the blocks one by one. FIGS. 4 show embedding patterns in block units (6×6 pixels). When the bit to be embedded is 0, the embedding pattern shown in FIG. 4A is used. In FIG. 4A, a coefficient for the shaded portion is −1, and a coefficient for a white portion is +1. The coefficient ×α (α>1) is superimposed on the block unit, and pixel values corresponding to the shaded portion of the pattern are increased by −α and pixel values corresponding to the white portion are increased by +α. As a result, a gradient is given to the pixel values within the block. When the bit to be embedded is 1, the pattern shown in FIG. 4B which has an antiphase is used for embedding.

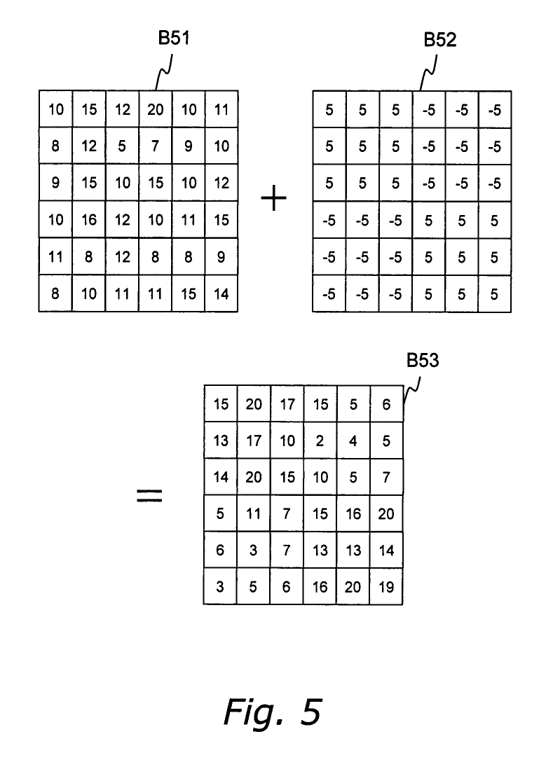

FIG. 5 is a diagram for illustrating the process at step 203 in FIG. 2 by showing specific pixel values. Reference numeral B51 denotes a portion of image data as a block unit. Reference numeral B52 denotes an embedding pattern. The pattern denoted by B52 is obtained by superimposing the coefficient ×5 onto the embedding pattern of the embedded bit 1 which is shown in FIG. 4B. By adding B51 and B52, the data denoted by B53 which has an electronic watermark embedded therein is obtained. Groups of pixel values in the upper left corner and the lower right corner of the data B53 are higher than those of the upper right corner and the lower left corner compared to those in the original data B51. It can be seen that a gradient is given in the block. An electronic watermark can be detected by determining additional information of 1 or 0 based on the gradient, as will be described below.

As described above, by performing embedding with a fixed proportion of the image size at the time of embedding to the block size, the additional information can be detected by using the proportion even after the resolution is changed arbitrarily.

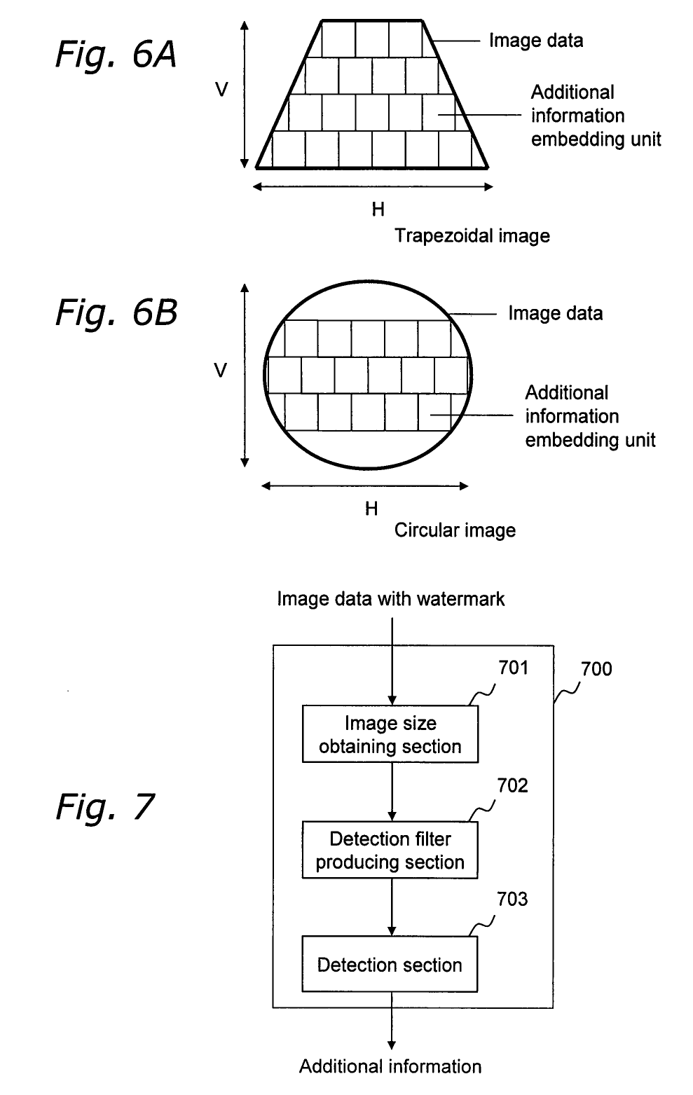

In the present embodiment, the image data has a rectangular shape of 360×240 pixels. However, the present invention is not limited to such image data. For example, a trapezoidal image or a circular image as shown in FIGS. 6A and 6B may be used. When the image has a trapezoidal shape, a block size n, m is calculated with the number of the pixels of the upper side or the lower side being H as mentioned above and the number of the pixels in the height direction being V as mentioned above. When the image has a circular shape, the block size can be calculated similarly with the major axis and the minor axis (in the case of a perfect circle, major axis=minor axis) being respectively H and V (or vice versa).

In step 202 as shown in FIG. 2, the size of the block is calculated based on both the dimension in the horizontal direction and the dimension in the vertical direction of the image data. However, the present invention is not limited to such an example. Only one of the dimension in the horizontal direction and the dimensions in the vertical direction may be used for calculation. Further, the proportion which results in the block size of 6×6 pixels is used, but the present invention is not limited to such a proportion. The dimension in the horizontal direction and the dimension in the vertical direction of the block may be different. However, if the block size is too small, the tolerance is deteriorated. On the contrary, if the block size is too large, the image degradation due to embedding becomes significant.

Moreover, the way of associating an additional information bit used in step 203 shown in FIG. 2 and the embedding pattern are not limited to those as described above. Any method and pattern can be used as long as they are consistent for embedding and detection.

Further, in the present embodiment, a method of adding a pattern (FIG. 4) which is one of image spatial domain employing type methods is shown as the method for embedding electronic watermarks. However, any other method of image spatial domain employing type may be used. Alternatively, a method of a frequency domain employing type in which an image is converted to frequency components to manipulate a conversion coefficient may be used. An exemplary method of the frequency domain employing type may be a method of performing DCT conversion in a block unit and changing a part of the DCT coefficients to give a gradient, which is similar to that in the embedding employing an embedding pattern, to the pixel values in the block.

Even when the embedding is performed by using a frequency domain as described above, detection is performed by a method of an image space employing type as will be described below. This is because, if the detection is performed using frequency domain, positions of the manipulated frequency coefficients may be changed when the image size at embedding and the image size at the detection are different as described in the present invention. Thus, the position of detection may be shifted in such a case. Accordingly, in the present invention, even when the embedding is performed utilizing frequency domain, the detection is performed utilizing the pixel space. As a result, an effect of the present invention, which allows the image size to be disregarded, can be obtained.

### Embodiment 2

Next, an electronic watermark detection device according to Embodiment 2, which is a device for detecting additional information from the image data which watermarks are embedded in Embodiment 1, will be described.

FIG. 7 is a block diagram of an electronic watermark detection device 700 according to Embodiment 2.

As shown in FIG. 7, the electronic watermark detection device 700 according to Embodiment 2 includes an image size obtaining section 701, a detection filter producing section 702, and a detection section 703.

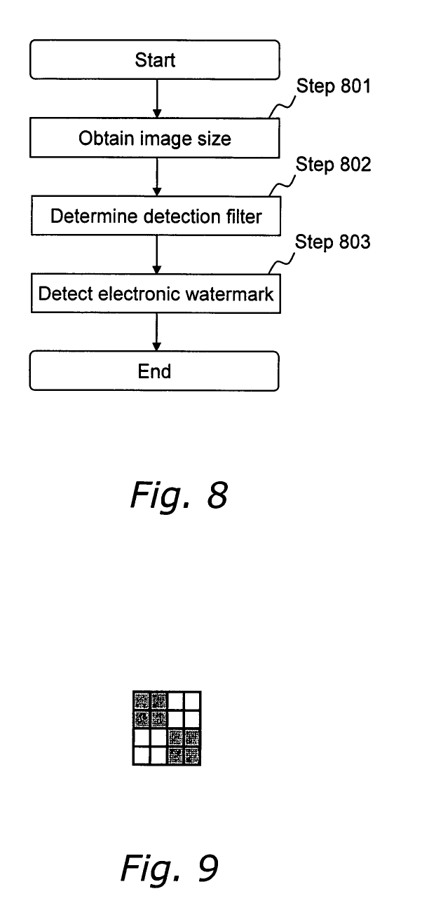

Hereinafter, the electronic watermark detection device 700 of Embodiment 2 will be described with further reference to FIG. 8. FIG. 8 is a flow diagram for the electronic watermark detection device 700 of FIG. 7.

First, the image size obtaining section 701 obtains the horizontal direction dimension H and the vertical direction dimension V from the image data with the additional information being embedded (step 801). In this example, the input image data is supposed to be image data with the resolution having been converted through taking a photo with a camera or the like. For describing specifically, the image data is assumed as a rectangular image with H=240 (pixels) and V=160 (pixels).

Next, the detection filter producing section 702 produces a detection filter in accordance with the rules at the embedding (step 802). When the size of the detection filter is calculated in accordance with the rule that H:n=60:1 and V:m=40:1 are satisfied, which is used for determining the block size (m×n pixels) at the embedding, the size of 4×4 pixels as shown in FIG. 9 is obtained. The detection filter produced in this step has a similar shape as the embedding pattern used for embedding. Herein, the filter size is an integer. When the result of the calculation of the filter size is indivisible, the figure is rounded off to the nearest whole number, for example.

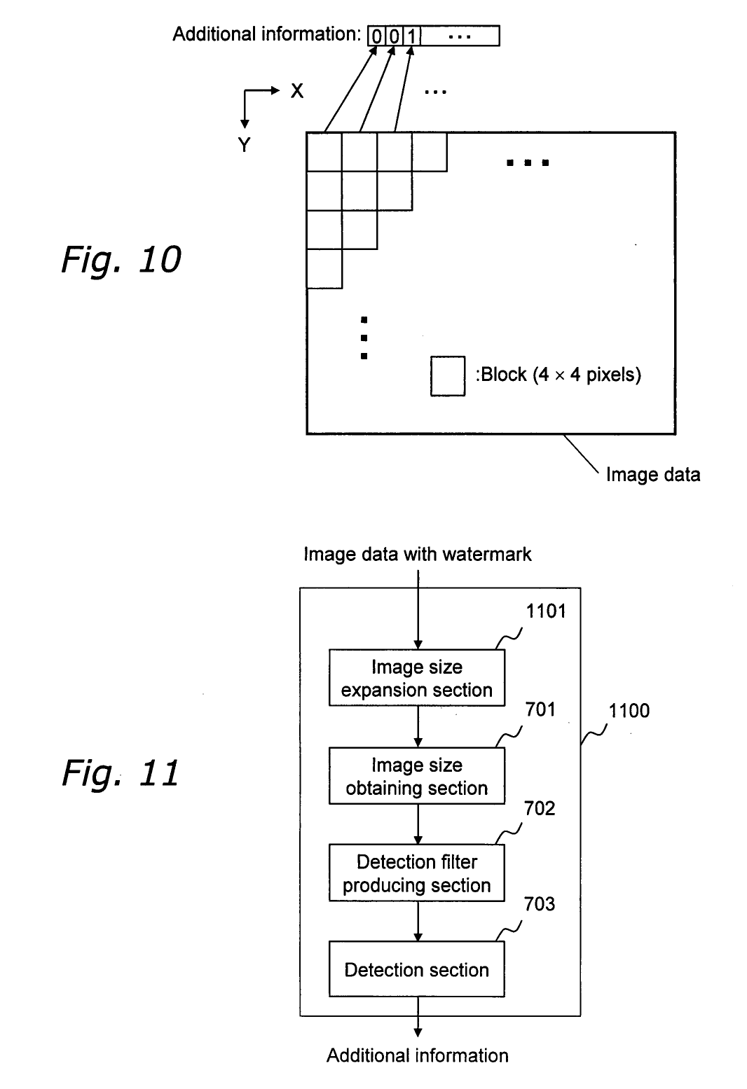

Lastly, the detection section 703 performs detection by the detection filter produced at step 802 and outputs the additional information (step 803). As shown in FIG. 10, the image data is divided into blocks by the size of the produced detection filter, and the correlation with the detection filter shown in FIG. 9 is calculated in an order from the upper left block to perform detection. The calculation of the correlation used in this example is performed by calculating the total sum of the values of the pixels in the block which are respectively multiplied by a corresponding coefficient, which is −1 for the shaded portion and +1 for the white portion, in the detection filter shown in FIG. 9. When the calculated value is not lower than the threshold value T (>0), the bit embedded in the block is determined to be 0. When the calculated value is −T or lower, the bit embedded in the block is determined to be 1.

For example, if there is image data as denoted by B53 in FIG. 5, the total sum of the values obtained by multiplying the pixel values of the data B53 by the coefficients of the detection filter as shown in FIG. 9 is −175. The value is over the threshold value and is a large negative numerical value. Thus, the bit embedded in the block of the image data can be determined to be 1. The bit is determined for each of the blocks in this way, and the additional information embedded in the image data is obtained.

As described above, the detection filter, which is produced in accordance with the rule for embedding, is used for detection, so the additional information can be detected even from the image data of which the resolution has been converted.

In the present embodiment, the image data of which the resolution has been converted is a rectangular image of 240×160 pixels. However, the present invention is not limited to such an example.

In step 802, one detection filter corresponding to the embedded bit of 0 is produced. Since two embedding patterns used in Embodiment 1 are in opposite phase, the description on producing a filter corresponding to the embedded bit of 1 is omitted. The number and the shape of the filters are not limited as long as they correspond to the embedding patterns.

The calculation on the correlation which is used in step 803 is not limited to this. Any type of calculation may be used as long as it can be determined whether the embedded bit is 0 or 1 from the result of calculation.

### Embodiment 3

Next, an electronic watermark detection device according to Embodiment 3, which is a device for detecting additional information from the image data which a watermark is embedded in Embodiment 1, will be described.

FIG. 11 is a block diagram of an electronic watermark detection device 1100 according to Embodiment 3.

As shown in FIG. 11, the electronic watermark detection device 1100 according to Embodiment 3 includes an image size expansion section 1101, an image size obtaining section 701, a detection filter producing section 702, and a detection section 703. In FIG. 11, the same elements as those in FIG. 7 are denoted by the same reference numerals, and will not be further described.

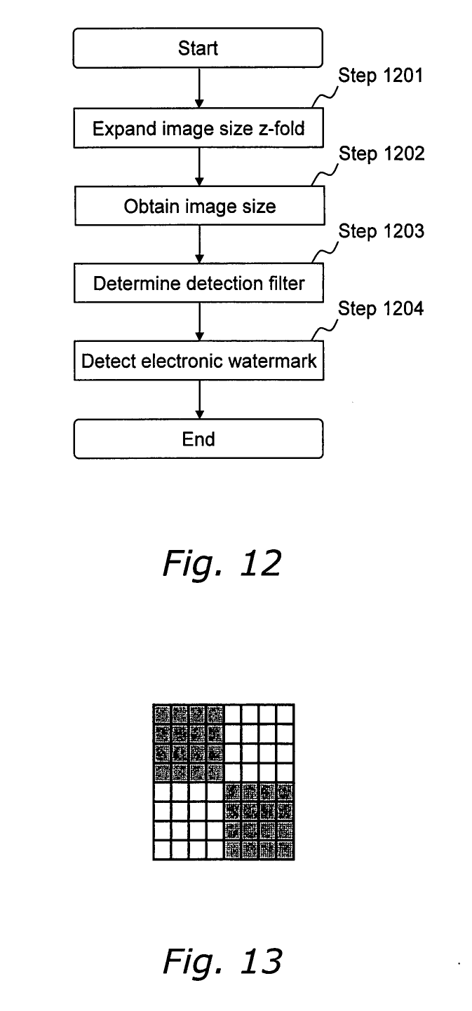

Hereinafter, the electronic watermark detection device 1100 of Embodiment 3 will be described with further reference to FIG. 12. FIG. 12 is a flow diagram for the electronic watermark detection device 1100 of FIG. 11.

First, the image size expansion section 1101 expands the image data with the additional information being embedded, at a magnification of Z times (step 1201). For describing specifically, it is assumed that Z=2. When the image data before expansion is assumed as a rectangular image having the size of H=240 (pixels) and V=160 (pixels), the image is expanded to have H=480 (pixels) and V=320 (pixels).

A process of steps 1201 through 1204 is the same as the process of steps 801 through 803 in Embodiment 2. However, since the image size is expanded twofold by the image size expansion section 1101, the size of the detection filter is also doubled, which is 8×8 pixels as shown in FIG. 13.

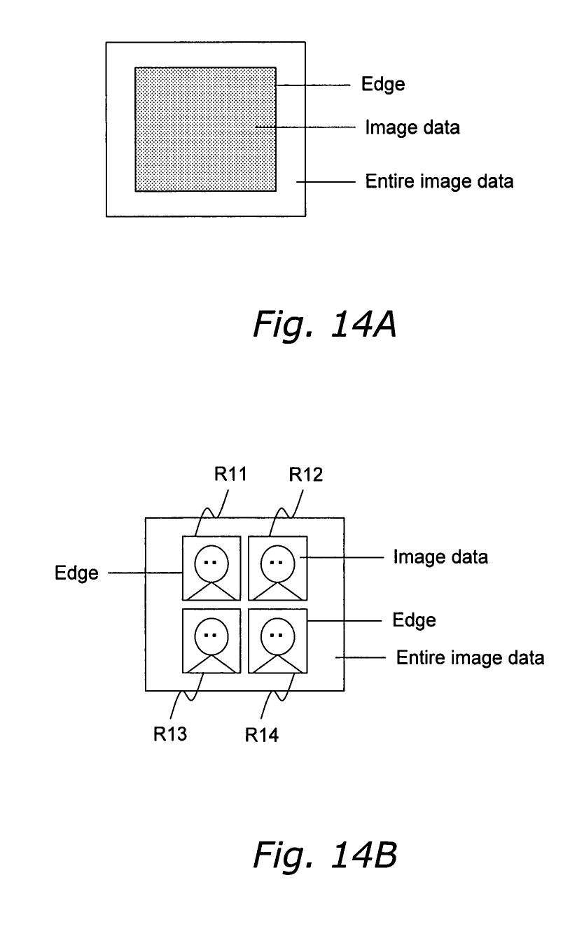

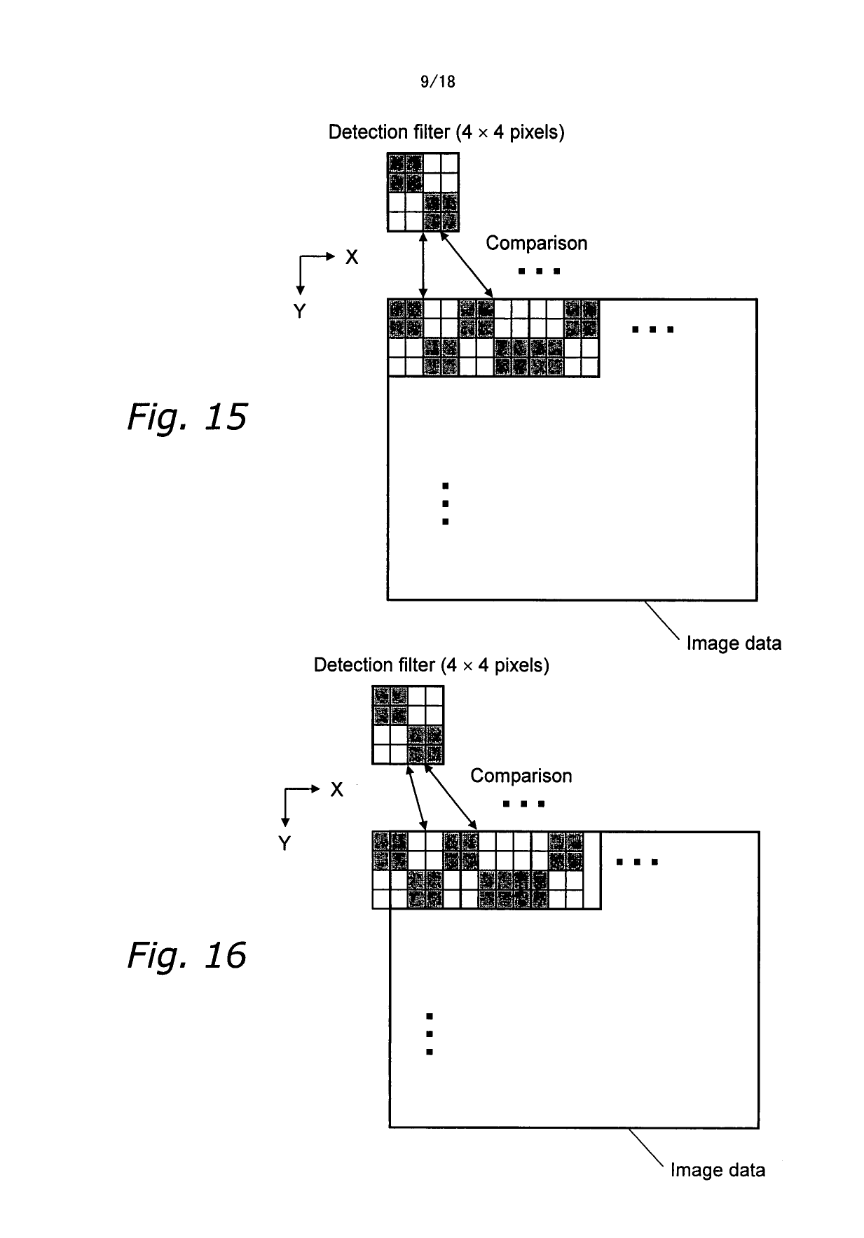

By expanding the image size as described above, the positional shift in detection may be generated. For example, a specific case may be as follows. When an analog process is involved, for example, a photo of a printed image with a watermark is taken by an optical device such as a camera, and the image data is cut out from the captured entire image data by edge detection (FIG. 14A). In such a case, when the edge of the image data itself is not clear, or has a certain width, the positional shift easily occurs. Even when the process is performed entirely digitally, if the entire image data includes a plurality of image data pieces, which are cut out by the edge detection (FIG. 14B), the positional shift easily occur if the edge itself has a certain width. According to the present embodiment, the tolerance to such a positional shift which occurs when electronic watermarks are detected can be improved. A function of an expanded detection filter shown in FIG. 13 to prevent such a positional shift will be described with reference to FIGS. 15 through 17.

FIG. 15 is a schematic diagram of a detection process in Embodiment 2. As shown in FIG. 15, an image data with an electronic watermark being embedded has a gradient in pixel values in each block (4×4 pixels) depending upon the embedding pattern. Each block unit is compared with the detection filter (4×4 pixels) corresponding to bit 0, and the value of the embedded bit is determined. In the example shown in FIG. 15, the bit embedded in each block can be accurately detected since there is no positional shift. However, as shown in FIG. 16, when there is a positional shift in X direction by one pixel, in comparison of the upper left block to the detection filter, it cannot be determined whether the bit is 0 or 1 because the extent of correlation is not sufficiently large with both the detection filter corresponding to bit 0 as shown in FIG. 16 and the detection filter corresponding to bit 1 which has an antiphase. In such a case, the detection may have an erroneous result. The tolerance to the positional shift is low.

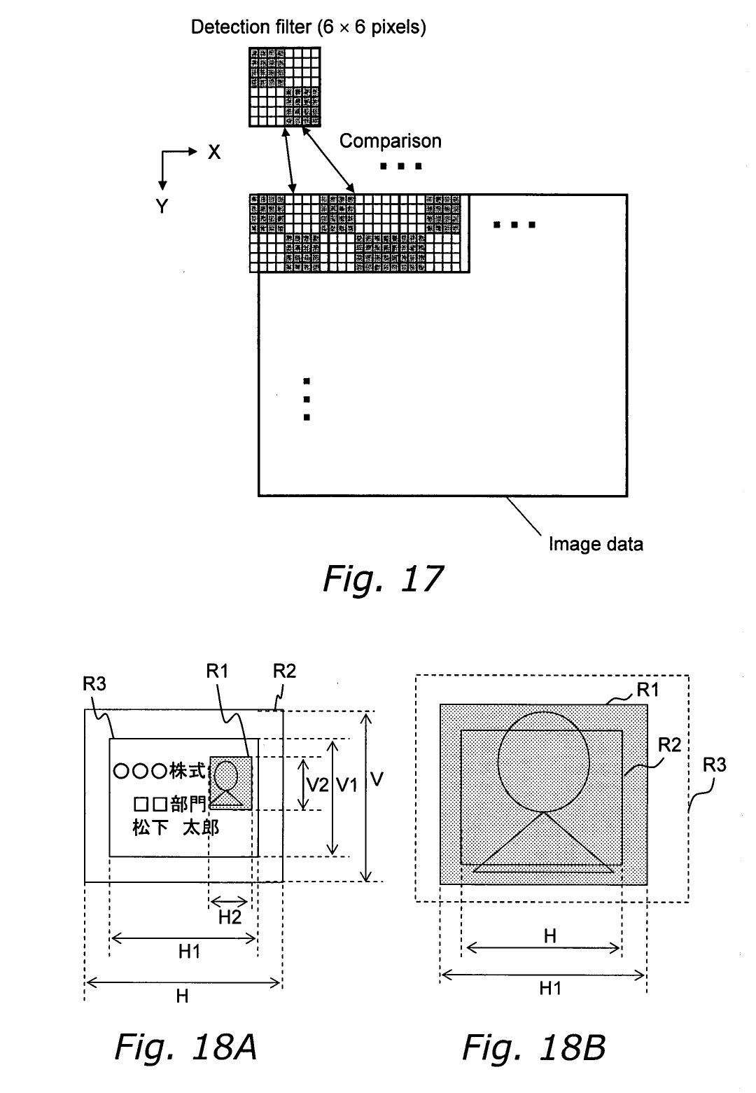

Thus, according to Embodiment 3, the image is expanded to have the detection filter of the size of 8×8 pixels as shown in FIG. 17. In this way, even when the image is shifted in X direction by one pixel, the upper left block has a large degree of correlation with the detection filter corresponding to a bit 0. Thus, the bit can be detected to be 0.

As described above, by expanding the image size upon detection, the detection tolerance to the positional shift can be improved.

### Embodiment 4

Next, an electronic watermark detection device according to Embodiment 4 will be described.

An object of the electronic watermark detection device of the present embodiment is to appropriately detect electronic watermark information even when an area of image data R1 with an electronic watermark being embedded (hereinafter, referred to as embedded image data) and an area of image data R2 from which the detection device detects the electronic watermark (hereinafter, referred to as entire image data) do not match each other.

FIGS. 18 are diagrams showing an example in which the area of the embedded image data and the area of the entire image data do not match. In FIG. 18A, the hatched area R1 is an area of the image data with the electronic watermark being embedded. In the figure, the area R2 is an area of the entire image data stored or input, from which the detection device detects the electronic watermark data. Such a mismatch may happen, for example, when a photo of a printed material, on which the embedded image data with the electronic watermark is printed, is taken by an optical device such as a camera first, and then, the electronic watermark is detected from the entire image data obtained by taking the photo. Such a case may be a case where the area of the taken photo (the entire image data R2) is larger than the embedded image data (FIG. 18A), or a case where the entire image data R2 is smaller than the embedded image data (FIG. 18B).

Another example of the case of the mismatch may be the case where an editing or processing process such as attaching the embedded image data to another image data is performed before the detection device performs a process for detecting an electronic watermark by using the detection film. When a new entire image data is produced in such a case, the area of the entire image data may also be larger than the area of the embedded image data (FIG. 18A).

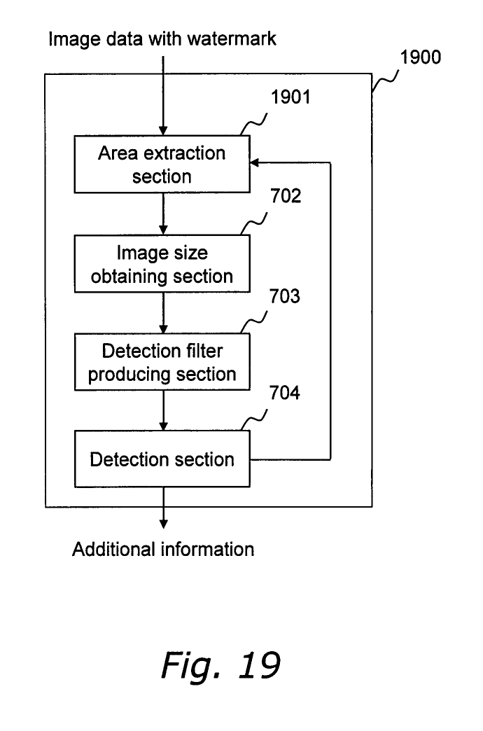

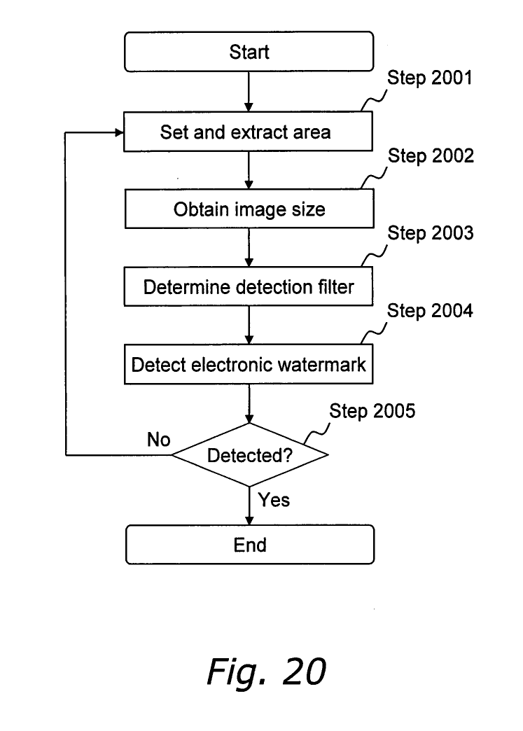

The electronic watermark detection device according to the present embodiment has a structure similar to the electronic watermark detection device of FIG. 7, but is different in that an area extraction section for the embedded image data is provided as shown in FIG. 19. Hereinafter, a detection device 1900 of the present embodiment will be described with reference to FIG. 20.

First, an area extraction section 1901 sets all of the input image data (entire image data) as the area in which the electronic watermark is embedded (step 2001). Next, the image detection size obtaining section 702 obtains the dimension in the horizontal direction of the obtained area (in the example shown in FIG. 18A, the number of the pixels H in the horizontal direction) and the dimension V in the vertical direction, (step 2002). Then, the detection filter producing section 703 calculates the size of the detection filter using the rule that H:n=60:1 and V:m=40:1 are satisfied, which is described as the rule for producing at the embedding in Embodiment 2 (step 2003). Next, the detection section 704 detects an electronic watermark by the detection filter produced in step 2003 (step 2004). The detection algorithm is similar to that in Embodiment 2, and thus, is not described further. Then, the detection section 704 determines whether detection of the additional information is performed normally or not (step 2005). For the determination, for example, determination with threshold as mentioned in Embodiment 2 can be used. When the filter calculation is performed for an area which does not include a watermark, normally, a value close to 0 is obtained. Thus, by setting the threshold value T to a certain degree of value, whether there is a watermark or not can be determined and it becomes possible to prevent erroneous detection. For performing further precise determination, encoding the additional information by using an error detection code or an error correction code is effective.

As a result of determination at step 2005, if it is determined that the detection is performed normally, the operation is finished (step 2005=YES). As a result of determination, if it is determined that the detection is not performed normally, the process returns to the setting of area and the extraction process at step 2001 (step 2005=NO).

The process returns to step 2001, and the area extraction section 1901 detects an area smaller than the entire image, which is a rectangular area having dimensions smaller than the pixel number H in the horizontal direction and smaller than the pixel number V in the vertical direction. A specific method of the detection process is as follows. When the image data is a typical photograph image, the photograph image and a surrounding background image generally have largely different frequency distributions, average luminance, and average color differences of the image. Thus, the image data is cut out by detecting the edge around the image data so the detection is realized. This method can be readily performed according to conventional techniques such as filtering process using a high-pass filter. Such a process is performed, and the area R3 in the figure (the position of the edge) is extracted. In the edge detection, a margin of error by few pixels may be generated. Such an error does not have an influence as long as the image data has a certain size and the ratio of H:n (or V:m) is sufficiently large. For example, if the horizontal dimension of the image data is 103 (in which the margin of error is 3 pixels) and the ratio is 10:1, the filter size is 10.3. When the figure is rounded off to the whole number and expressed in an integer, the size is 10 and the margin of error is absorbed.

Next, again in step 2002, the image size obtaining section 702 obtains the dimension in the horizontal direction of the obtained area R3 (in the example shown in FIG. 18A, the number of pixels H1 in the horizontal direction) and the dimension V1 in the vertical direction. The size can be obtained by a subtraction process between horizontal coordinates and between vertical coordinates of the edge positions of the area extracted by the previously described process, for example.

Thereafter, the horizontal direction dimension and vertical direction dimension of the detection filter is determined for the extracted area similarly. Then, the size of the detection filter is calculated, and the calculated detection filter is used to repeat the process until it is determined that the detection is normally performed (steps 2001 through 2005). Specifically, when the area extraction section 1901 extracts the area R1, the size of the image data in which the electronic watermark embedding device embeds an electronic watermark and the size of the image data (extraction area) for determining the horizontal dimension and the vertical dimension of the detection filter match. Thus, the electronic watermark information can be extracted appropriately. Such a structure allows detecting the electronic watermark information appropriately even when the embedded image data is included in the entire image data.

In this embodiment, the condition for finishing the process is that detection is completed normally. However, the present invention is not limited to such an example. The condition for finishing the process may be such that search for all of the detection target areas is completed. For example, such a condition may be utilized when there are a plurality of embedded image data pieces in the entire image data as shown in FIG. 14B. First, the area R11 is extracted, and the detection of the watermark is performed by the above-described steps. After the determination is completed, the area R12 is extracted and detection is performed. The detection for the following areas R13 and R14 is performed similarly, and the search for all the areas is completed. With such a process, the detection of a watermark can be performed for all areas included in the entire image. cl Variation of Embodiment 4

A variation of the electronic watermark detection device of Embodiment 4 will be described.

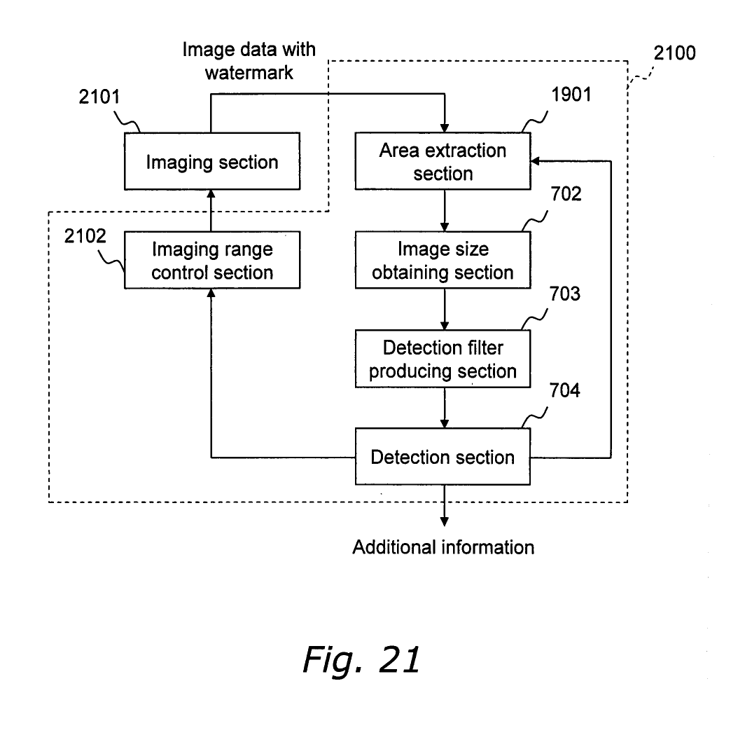

An object of an electronic watermark detection device 2100 according to the present variation is to appropriately detect electronic watermark information when an area of image data with an electronic watermark being embedded (hereinafter, referred to as embedded image data) and an area of image data from which the detection device detects the electronic watermark (hereinafter, referred to as entire image data) do not match each other, similarly to the above-described electronic watermark detection device of Embodiment 4. The electronic watermark detection device 2100 of the present variation has a structure generally similar to that of the electronic watermark detection device of Embodiment 4. However, as shown in FIG. 21, it is different in that an imaging section 2101 and an imaging range control section 2102 are further provided.

The imaging section 2101 includes an optical lens, and photoelectric conversion element such as CCD sensor, CMOS sensor or the like, and outputs image data of a range obtained by taking a photo of a predetermined area. The output image data is input to the area extraction section 1901 as image data with the watermark as in Embodiment 4.

The imaging range control section 2102 controls a position of the lens in the imaging section 2101. Even the number of pixels of the image data is the same, the range of taken photo can be expanded or reduced.

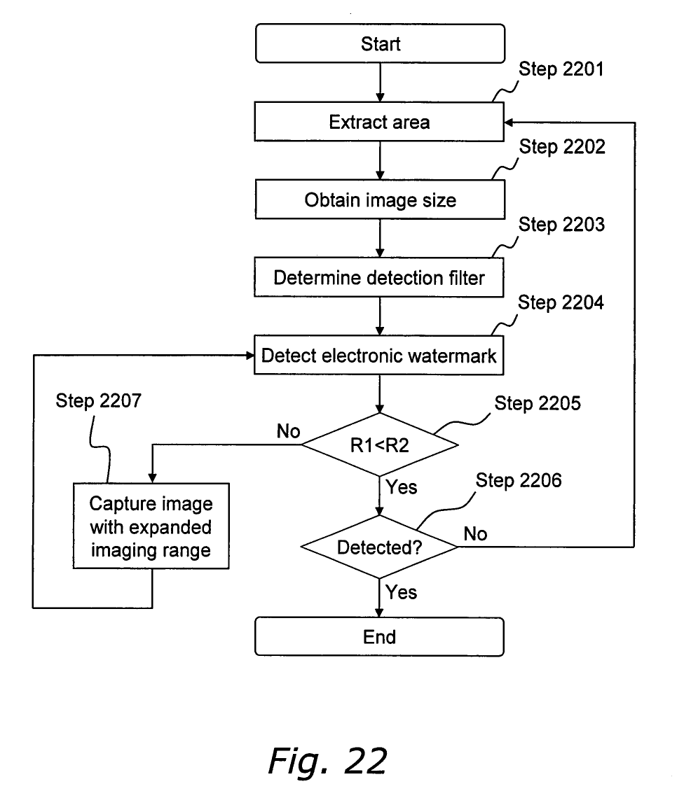

Next, an operation of the electronic watermark detection device 2100 of the present variation will be described with reference to FIG. 22. First, the imaging section 2101 takes a photo of a printed material with an electronic watermark being embedded within an imaging range of an initial state which is stored in the imaging range control section 2102 to obtain the image data. For the sake of description, the imaging range of the initial state is denoted by reference numeral R2 in FIG. 18B and the area with the electronic watermark being embedded is denoted by reference numeral R1 in the same figure. Then, the process of steps 2201 through 2204 shown in FIG. 22 is performed as in Embodiment 4. Specifically, the horizontal and vertical dimensions of the detection filter are determined based on the horizontal pixel number H and the vertical pixel number V, and the electronic watermark is detected based on the detection filter of the determined size.

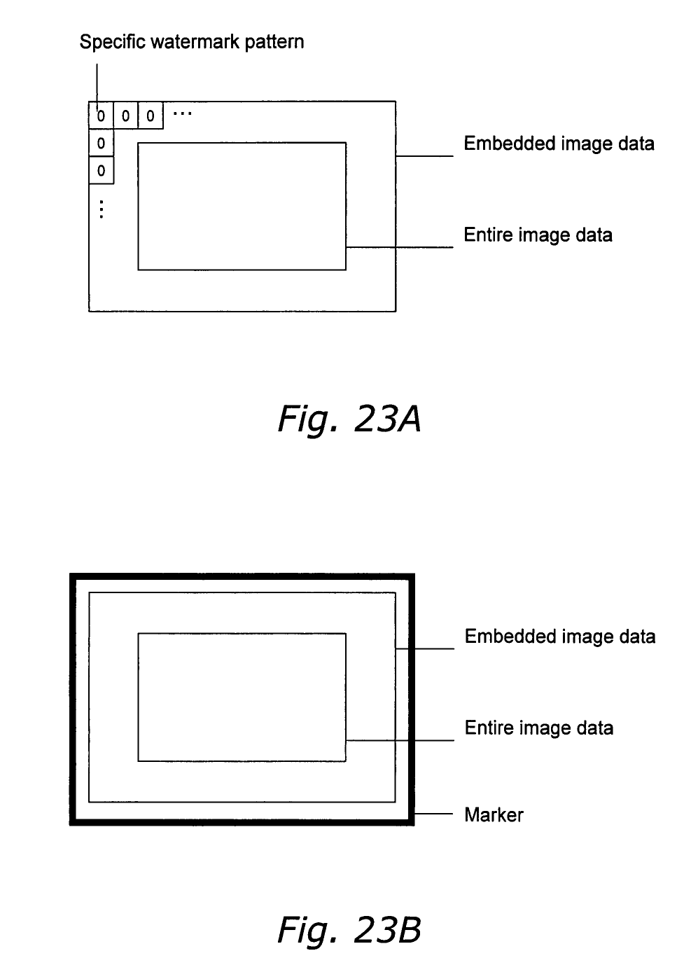

In this embodiment, at step 2205, whether the area R1 with the electronic watermark being embedded is smaller than the area R2 of which a photo is taken or not is determined. For determining, for example, a specific pattern (for example, information of all 0 or 1) may be embedded in an outermost periphery as shown in FIG. 23A when the watermark is embedded. The steps 2204, 2205, and 2207 may be repeated until the specific pattern is detected. Alternatively, a visible marker as shown in FIG. 23B, for example, may be printed in advance instead of the specific pattern. The steps 2204, 2205, and 2207 may be repeated until the marker is included within the imaging range.

As a result of the determination, if the area R1 is determined to be smaller than the imaging range R2 (step 2205=Yes), the electronic watermark is definitely within the image data of which a photo is taken. Thus, the electronic watermark information can be appropriately obtained by performing a process similar to that in Embodiment 4. On the other hand, as a result of determination, if the area R1 is determined to be not smaller than the imaging range R2 (step 2205=No), the imaging range control section 2207 changes the position of the optical lens. The imaging range is expanded (for example, by 1.5 times) to the area denoted by R3 in FIG. 18B and a photo is taken. This process is repeated until the embedded image data including the electronic watermark information is definitely within the entire image data of the imaging range. Thus, in the following process, the electronic watermark information can be obtained by performing a process similar to that of Embodiment 4.

As described above, according to the electronic watermark detection device of the present variation, an electronic watermark can be detected even when a user takes a photo of an entire image data without recognizing where the watermark is embedded.

Further, according to the present variation, a camera automatically zoom in or zoom out to take a photo of the image data including an electronic watermark even when the image data cannot be cut out from the entire image data obtained by taking a photo with a camera, or when an electronic watermark cannot be detected from the cut out image data. This allows a user to avoid a cumbersome process of moving a camera toward/from an object, and the watermark detection can be performed preferably.

### Embodiment 5

Next, an information processing device for running a program for embedding electronic watermark to image data in Embodiment 4 of the present invention will be described.

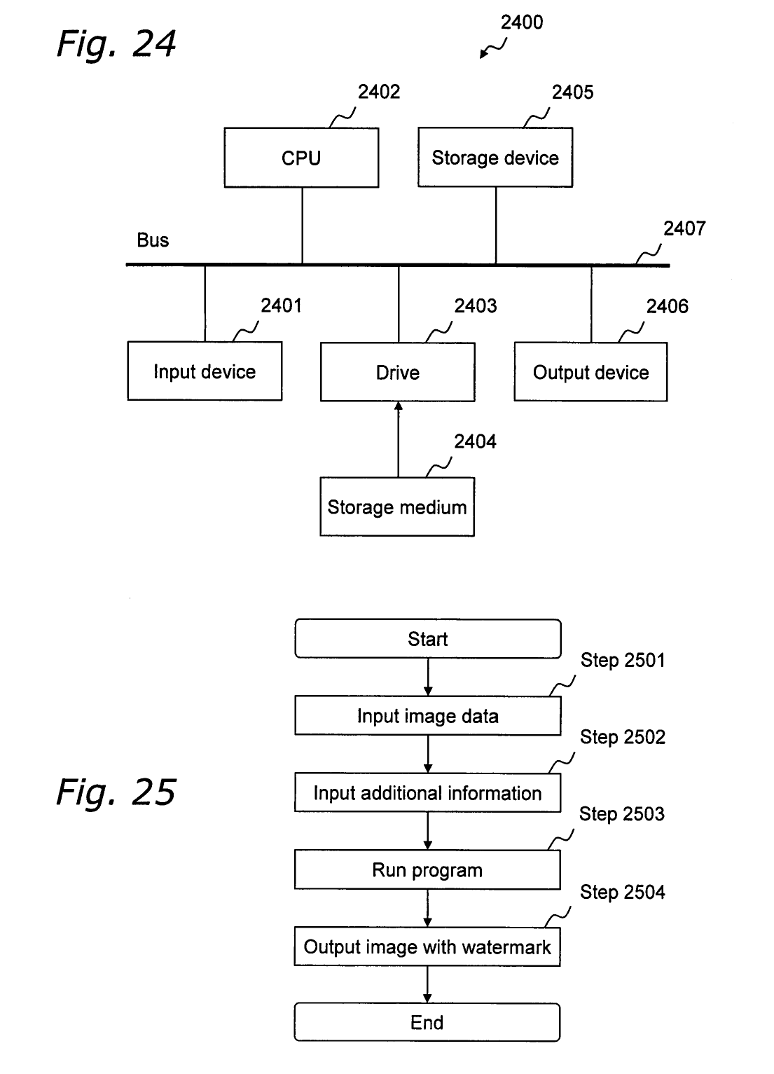

FIG. 24 is a block diagram of an information processing device 2400 according to Embodiment 5. As shown in FIG. 24, the information processing device 2400 of the present embodiment includes an input device 2401 such as a keyboard, mouse, camera, scanner, or the like, a storage device 2405 which stores predetermined program data including a program for performing processes according to the present invention (ROM, RAM, hard disc, or the like), a CPU (central processing unit) 2402 which runs the program data, an output device 2406 such as a display, printer or the like, and the like, which are connected to each other via bus 2407. The program data may be introduced from a recording medium 2404 such as a CD-ROM, flexible disc, or the like via a drive 2403.

Hereinafter, the information processing device 2400 according to the present embodiment will be described with further reference to FIG. 25. FIG. 25 is a flow diagram of a process by the information processing device 2400 according to the present embodiment.

First, the input device 2401 receives an input of image data in which an electronic watermark stored in the storage device 2405 is to be embedded (step 2501). The image data may be introduced from the recording medium 2404 via the drive 2403. Then, the input device 2401 receives an input of additional information to be embedded to the image data (step 2502). As the additional information, the information stored in the storage device may be used. Alternatively, the additional information may be input from the recording medium 2404 via the drive 2403.

Next, the CPU 2402 runs the electronic watermark embedding program stored in the storage device 2405 and produces an image with the watermark (step 2503).

Lastly, the image with the watermark is output to the output device 2406 such as a display, printer, or the like.

### Embodiment 6

Next, an information processing device which stores a program for detecting an electronic watermark from image data with the electronic watermark being embedded according to Embodiment 6 of the present invention will be described. The structure of the information processing device of the present embodiment is the same as that of the information processing device 2400 shown in FIG. 24, and thus, it is not shown in a figure.

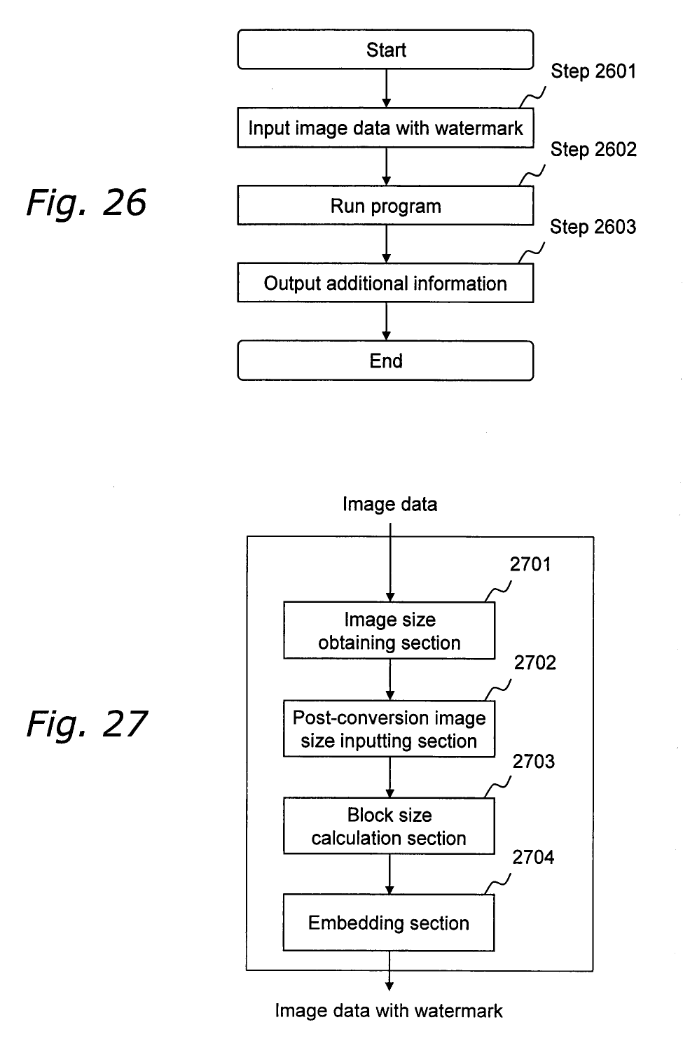

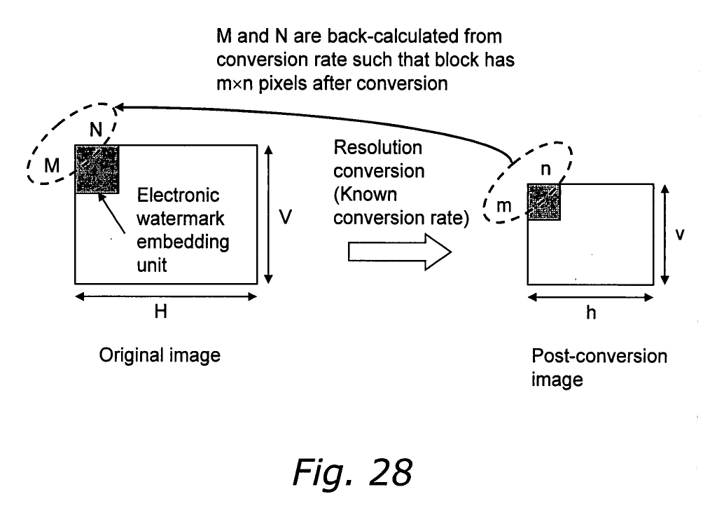

Hereinafter, a process by the electronic watermark detection program which is run by the information processing device of the present embodiment will be described with reference to FIG. 26. The program is stored in the storage device 2405.

First, the input device 2401 receives an input of image data with the watermark which is to be detected (step 2601). Typically, the input device 2401 receives an input of the image data which is captured by using a camera as an input device.

Next, the CPU 2402 runs the electronic watermark detection program stored in the storage device 2405 and detects the additional information (step 2602).

Lastly, the detected additional information is output to the output device 2406 such as a display, printer, or the like.

The rules used in the program (proportion of the image size to the embedding pattern, and the like) are common to the rules at embedding. Thus, the same rules as those used at embedding may be included in the program, or the same rules as those used at embedding may be introduced from the input device, storage device, or the recording medium when the program is running.

### Others

In the electronic watermark embedding devices and electronic watermark detection devices as described in Embodiments 1 through 4, each of the blocks may be individually made into one chip or part or all of the blocks may be made into one chip by a semiconductor device such as LSI.

Although, the term LSI is used above, it may also be called IC, system LSI, super LSI, or ultra LSI, depending upon a degree of integration.

A method for integrating circuit is not limited to LSI. A circuit of specific application, or a general use processor may be used for implementation. A FPGA (field programmable gate array) which can be programmed after fabrication of LSI, or a reconfigurable processor which allows reconfiguration of connection or setting of circuit cells inside LSI may be employed.

In advent of a technique for integrating circuit which will replace LSI by advancement in semiconductor technology or another technology derived therefrom, functional blocks may be integrated using such a technique. Application of biotechnology is one possibility.

### INDUSTRIAL APPLICABILITY

An image processing device according to the present invention detects additional information, which is embedded as an electronic watermark, from the image data so it can be used for obtaining information from the image data of which a photo is taken by a camera, for example.

1-16. (canceled)

17. An electronic watermark detection device for detecting an electronic watermark from image data in which the electronic watermark is embedded, comprising:
an image size obtaining section configured to obtain an image size of an input image;
an image size expanding section configured to produce image data expanded at a magnification of Z times (Z>1) of the image size;
a detection filter producing section configured to calculate a size of a detection filter so as to be expanded at the magnification of Z times based on the expanded image size; and
a detection section configured to detect the electronic watermark using correlation between the detection filter and the image data both of which have been expanded at the magnification of Z times.

18. The electronic watermark detection device according to claim 17, wherein the image data is data of an image which is taken by a camera.

19. The electronic watermark detection device according to claim 17, further comprising an extraction section configured to extract the image data from a second image data which includes the image data.

20. The electronic watermark detection device according to claim 19, wherein the second image data is data of an image which is taken by a camera.

21. The electronic watermark detection device according to claim 19, wherein the extraction section obtains edge information based on at least one of frequency information, luminance information, color information of the second image data, and extracts the image data.

22. The electronic watermark detection device according to claim 20, further comprising an imaging range control section configured to control an imaging range of the camera, wherein:
the imaging range control section controls the imaging range depending upon whether the detection section detects the electronic watermark or not.

23. An electronic watermark detection method for detecting an electronic watermark from image data in which the electronic watermark is embedded, comprising:
an image size obtaining step of obtaining an image size of an input image;
an image size expanding step of producing image data expanded at a magnification of Z times (Z>1) of the image size;
a detection filter producing step of calculating a size of a detection filter so as to be expanded at the magnification of Z times based on the expanded image size; and
a detecting step of detecting the electronic watermark using correlation between the detection filter and the image data both of which have been expanded at the magnification of Z times.

24. A program for having a computer carrying out an electronic watermark detection method for detecting an electronic watermark from image data in which the electronic watermark is embedded, comprising:
an image size obtaining step of obtaining an image size of an input image;
an image size expanding step of producing image data expanded at a magnification of Z times (Z>1) of the image size;
a detection filter producing step of calculating a size of a detection filter so as to be expanded at the magnification of Z times based on the expanded image size; and
a detecting step of detecting the electronic watermark using correlation between the detection filter and the image data both of which have been expanded at the magnification of Z times.

25. An integrated circuit device for detecting an electronic watermark from image data in which the electronic watermark is embedded, comprising:
an image size obtaining section configured to obtain an image size of an input image;
an image size expanding section configured to produce image data expanded at a magnification of Z times (Z>1) of the image size;
a detection filter producing section configured to calculate a size of a detection filter so as to be expanded at the magnification of Z times based on the expanded image size; and
a detection section configured to detect the electronic watermark using correlation between the detection filter and the image data both of which have been expanded at the magnification of Z times.
